(19) United States
(12) Patent Application Publication
(10) Pub. No.: US 2023/0262826 A1
(43) Pub. Date: Aug. 17, 2023

(54) COMMUNICATION CONTROL METHOD

(71) Applicant: KYOCERA CORPORATION, Kyoto (JP)

(72) Inventors: Masato FUJISHIRO, Yokohama-shi (JP); Amit KALHAN, San Diego, CA (US); Henry CHANG, San Diego, CA (US)

(73) Assignee: KYOCERA CORPORATION, Kyoto (JP)

(21) Appl. No.: 18/295,033

(22) Filed: Apr. 3, 2023

Related U.S. Application Data
(63) Continuation of application No. PCT/JP2021/036422, filed on Oct. 1, 2021.
(60) Provisional application No. 63/086,141, filed on Oct. 1, 2020.

(51) Int. Cl. H04W 76/20; H04W 24/10

(52) U.S. Cl. CPC H04W 76/20; H04W 24/10; H04W 92/18

(57) ABSTRACT

An embodiment provides a communication control method in a mobile communication system including a first user equipment and a second user equipment. The first user equipment and the second user equipment communicate wirelessly with each other by sidelink communication. The communication control method includes, by the first user equipment in a PC5-Radio Resource Control (RRC) connected state with the second user equipment, measuring a channel utilization of a radio resource used for the sidelink communication and transmitting the measured channel utilization to the second user equipment. Furthermore, the communication control method includes receiving, by the second user equipment, the channel utilization.

### RELATED APPLICATIONS

The present application is a continuation based on PCT Application No. PCT/JP2021/036422, filed on Oct. 1, 2021, which claims the benefit of U.S. Provisional Application No. 63/086,141 filed on Oct. 1, 2020. The content of which is incorporated by reference herein in their entirety.

### TECHNICAL FIELD

The present invention relates to a communication control method used in a mobile communication system.

### BACKGROUND OF INVENTION

The Third Generation Partnership Project (3GPP), which is a standardization project for mobile communication systems, has defined a standard for sidelink communication in which user equipments communicate wirelessly with each other (for example, see NPL 1). The sidelink communication enables implementation of, for example, Vehicle to Everything (V2X) services including Vehicle to Vehicle (V2V) communication.

In the sidelink communication, user equipments may communicate wirelessly with each other by using resources scheduled by the Next Generation-Radio Access Network (NG-RAN) (mode 1). In the sidelink communication, a user equipment may autonomously select resources from a resource pool for wireless communication (mode 2).

When the user equipment is within a coverage range of the NG-RAN, the sidelink communication is supported regardless of the Radio Resource Control (RRC) state of the user equipment. Furthermore, the sidelink communication is supported even when the user equipment is outside the coverage range of the NG-RAN.

Thus, for example, when the user equipment is within the coverage range of the NG-RAN, the user equipment can communicate wirelessly with another user equipment by using scheduled resources or can autonomously select resources for wireless communication. On the other hand, when the user equipment is outside the coverage range of the NG-RAN, the user equipment can autonomously select resources and communicate wirelessly with another user equipment.

The sidelink communication supports unicast transmission, groupcast transmission, and broadcast transmission. In the unicast transmission, paired peer user equipments transmit and receive user traffic to and from each other. In the groupcast transmission, user equipments belonging to a group within the sidelink transmit and receive user traffic to and from each other. In the broadcast transmission, user equipments within the sidelink transmit and receive user traffic to and from each other.

### CITATION LIST

### Non-Patent Literature

NPL 1: 3GPP TS 38.300 V16.2.0 (2020-07)

### SUMMARY

In a first aspect, a communication control method is a communication control method in a mobile communication system including a first user equipment and a second user equipment. The first user equipment and the second user equipment communicate wirelessly with each other by sidelink communication. The communication control method includes, by the first user equipment in a PC5-Radio Resource Control (RRC) connected state with the second user equipment, measuring a channel utilization of a radio resource used for the sidelink communication and transmitting the channel utilization that is measured to the second user equipment. Furthermore, the communication control method includes receiving, by the second user equipment, the channel utilization.

In a second aspect, a communication control method is a communication control method in a mobile communication system including a first user equipment and a second user equipment. The first user equipment and the second user equipment communicate wirelessly with each other by sidelink communication. The communication control method includes, by the first user equipment in a PC5-RRC connected state with the second user equipment, determining whether a radio resource to be used by the second user equipment for transmission is in use by a third user equipment and transmitting, to the second user equipment, information related to the radio resource when the first user equipment determines that the radio resource is in use by the third user equipment. Alternatively, the communication control method includes, by the first user equipment in a PC5-RRC connected state with the second user equipment, detecting a radio resource not in use in the sidelink communication and transmitting the radio resource not in use that is detected to the second user equipment. The communication control method further includes receiving, by the second user equipment, the information related to the radio resource, or the radio resource not in use.

In a third aspect, a communication control method is a communication control method in a mobile communication system including a first user equipment and a second user equipment. The first user equipment and the second user equipment communicate wirelessly with each other by sidelink communication. The communication control method includes transmitting, by the first user equipment in a PC5-RRC connected state with the second user equipment, timing information to the second user equipment, and receiving, by the second user equipment, the timing information.

### BRIEF DESCRIPTION OF THE DRAWINGS

FIG. 1 is a diagram illustrating a configuration example of a mobile communication system according to an embodiment.

FIG. 2 is a diagram illustrating a configuration example of a user equipment according to an embodiment.

FIG. 3 is a diagram illustrating a configuration example of a base station according to an embodiment.

FIG. 4 is a diagram illustrating a configuration example of a protocol stack of a user plane of a Uu interface.

FIG. 5 is a diagram illustrating a configuration example of a protocol stack of a control plane of the Uu interface.

FIG. 6 is a diagram illustrating a configuration example of a protocol stack of a PC5 user plane.

FIG. 7 is a diagram illustrating a configuration example of a protocol stack of a PC5 control plane.

FIG. 8A is a diagram for illustrating an example of a hidden node problem, and FIG. 8B is a diagram illustrating an operation example of PC5-RRC connection.

FIG. 9 is a diagram illustrating an operation example of Example 1.

FIG. 10 is a diagram illustrating an operation example of Example 2-1.

FIG. 11 is a diagram illustrating an operation example of Example 2-2.

FIG. 12 is a diagram illustrating an example in which user equipments are in sidelink communication.

FIG. 13 is a diagram illustrating an operation example of Example 3-1.

FIG. 14 is a diagram illustrating an operation example of Example 3-2.

FIG. 15 is a diagram illustrating an operation example of Example 3-3.

### DESCRIPTION OF EMBODIMENTS

A mobile communication system according to an embodiment will be described with reference to the drawings. In the description of the drawings, the same or similar parts are denoted by the same or similar reference signs.

Configuration of Mobile Communication System

First, a configuration example of a mobile communication system according to an embodiment will be described. While the mobile communication system according to an embodiment is a 3GPP 5G system, Long Term Evolution (LTE) may be at least partially applied to the mobile communication system.

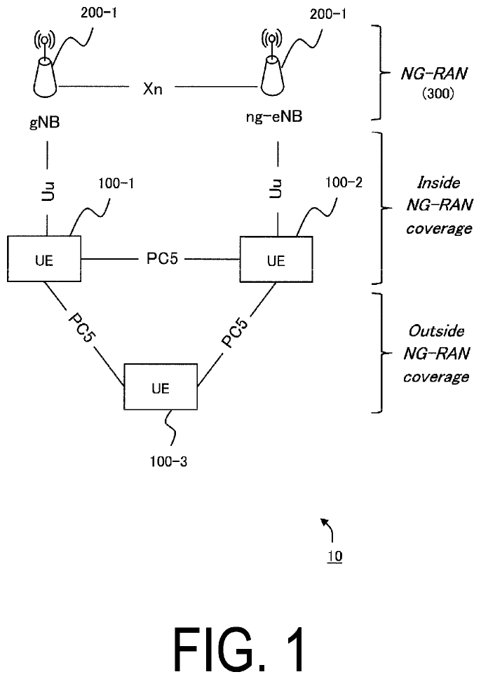

FIG. 1 is a diagram illustrating a configuration example of a mobile communication system 10 according to an embodiment.

As illustrated in FIG. 1, the mobile communication system 10 includes a user equipment (UE) 100, and a 5G wireless access network (NG-RAN) 300.

The UE 100 is a mobile apparatus. The UE 100 may be any apparatus as long as the apparatus is used by a user. Examples of the UE 100 include apparatuses that can perform wireless communication, such as a mobile phone terminal (including a smartphone), a tablet terminal, a laptop PC, a communication module (including a communication card or a chip set), a sensor, an apparatus provided on a sensor, a vehicle, an apparatus provided on a vehicle (Vehicle UE), a flying object, and an apparatus provided on a flying object (Aerial UE). Note that the UE 100 in the present embodiment can communicate directly wirelessly with another UE by using sidelink communication.

The NG-RAN 300 includes a base station apparatus 200-1 referred to as a “next generation Node B” (“gNB”) in the 5G system. The NG-RAN 300 includes a base station apparatus 200-2 that is an LTE base station capable of cooperating with New Radio (NR). The base station apparatus 200-2 is referred to as “ng-eNB”.

The gNB 200-1 and the ng-eNB 200-2 may be referred to as NG-RAN nodes. The gNB 200-1 and the ng-eNB 200-2 are interconnected via an Xn interface that is an inter-base station interface. The gNB 200-1 and the ng-eNB 200-2 manage one or more cells. Each of the gNB 200-1 and the ng-eNB 200-2 communicates wirelessly with the UE 100 that has established a connection to the cell of the gNB 200-1 or the ng-eNB 200-2. Each of the gNB 200-1 and the ng-eNB 200-2 has a radio resource management (RRM) function, a function of routing user data (hereinafter simply referred to as “data”), a measurement control function for mobility control and scheduling, and the like. The “cell” is used as a term representing a minimum unit of wireless communication area. The “cell” is also used as a term representing a function or a resource for performing wireless communication with the UE 100. One cell belongs to one carrier frequency.

As illustrated in FIG. 1, the gNB 200-1, and the ng-eNB 200-2 are connected to each other via an Xn interface. A Uu interface corresponding to an interface between the base station and the user equipment connects the gNB 200-1 and the UE 100-1 and connects the ng-eNB 200-2 and the UE 100-2. A PC5 interface corresponding to an inter-user-equipment interface connects the UEs 100-1 to 100-3 one another.

Note that the 3GPP defines NR sidelink communication and V2X sidelink communication. The NR sidelink communication is, for example, communication in which the New Radio (NR) technology is used to enable at least V2X communication among UEs 100-1 to 100-3 with no passage through a network node. The V2X sidelink communication is, for example, communication in which the Evolved-Universal Terrestrial Radio Access (E-UTRA) technology is used to enable V2X communication with no passage through a network node. Hereinafter, the NR sidelink communication and the V2X sidelink communication may be referred to as “sidelink communication” without being distinguished from each other. Thus, the “sidelink communication” may include the NR sidelink communication or the V2X sidelink communication.

In FIG. 1, the gNB 200-1 may be connected to a 5G Core network (5GC) corresponding to a core network of 5G, and the ng-eNB 200-2 may be connected to an Evolved Packet Core (EPC) corresponding to a core network of LTE. Alternatively, the gNB 200-1 may be connected to the EPC, and the ng-eNB 200-2 may be connected to the 5GC.

Note that of the gNB 200-1 and the ng-eNB 200-2, the gNB 200-1 will be described below as a representative example of the base station apparatus. The gNB 200-1 may be referred to as the gNB 200, and the UEs 100-1 to 100-3 may be referred to as the UE 100.

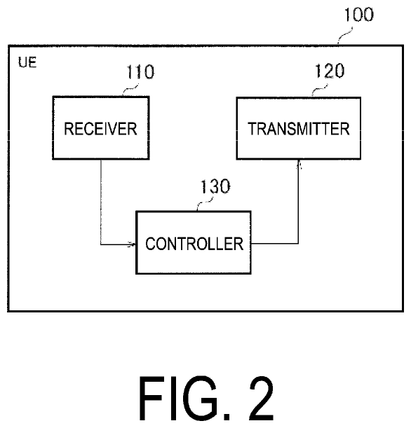

FIG. 2 is a diagram illustrating a configuration of the UE 100 (user equipment) according to an embodiment.

As illustrated in FIG. 2, the UE 100 includes a receiver 110, a transmitter 120, and a controller 130.

The receiver 110 performs various types of reception under control of the controller 130. The receiver 110 includes an antenna and a reception device. The reception device converts (down-converts) a radio signal received through the antenna into a baseband signal (a received signal) and outputs the resulting signal to the controller 130. Note that the UE 100 in the present embodiment can communicate wirelessly not only with the gNB 200 but also with another UE by sidelink communication. Accordingly, the receiver 110 can receive a message, data, or the like transmitted from another UE.

The transmitter 120 performs various types of transmission under control of the controller 130. The transmitter 120 includes an antenna and a transmission device. The transmission device converts (up-converts) a baseband signal output by the controller 130 (a transmission signal) into a radio signal and transmits the resulting signal through the antenna. In the present embodiment, the transmitter 120 can not only transmit data or the like to the gNB 200 but also transmit a message, data, or the like to another UE by sidelink communication.

The controller 130 performs various types of control in the UE 100. The controller 130 includes at least one processor and at least one memory electrically connected to the processor. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. The controller 130 according to the present embodiment can perform various types of control or processing described in Examples below.

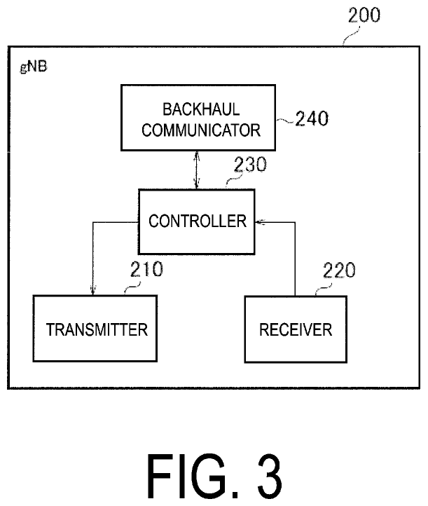

FIG. 3 is a diagram illustrating a configuration of the gNB 200 (base station) according to an embodiment.

As illustrated in FIG. 3, the gNB 200 includes a transmitter 210, a receiver 220, a controller 230, and a backhaul communicator 240.

The transmitter 210 performs various types of transmission under control of the controller 230. The transmitter 210 includes an antenna and a transmission device. The transmission device converts (up-converts) a baseband signal output by the controller 230 (a transmission signal) into a radio signal and transmits the resulting signal through the antenna.

The receiver 220 performs various types of reception under control of the controller 230. The receiver 220 includes an antenna and a reception device. The reception device converts (down-converts) a radio signal received through the antenna into a baseband signal (a received signal) and outputs the resulting signal to the controller 230.

The controller 230 performs various types of controls for the gNB 200. The controller 230 includes at least one processor and at least one memory electrically connected to the processor. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The CPU may be replaced by a processor or a controller, such as a digital signal processor (DSP) or a field programmable gate array (FPGA).

The backhaul communicator 240 is connected to a neighboring base station via the inter-base station interface. The backhaul communicator 240 is connected to each node of the 5GC via an interface between the base station and the core network. Note that the gNB 200 may include a Central Unit (CU) and a Distributed Unit (DU) (i.e., functions are divided), and the two units may be connected via an F1 interface.

Protocol Stack in Uu Interface

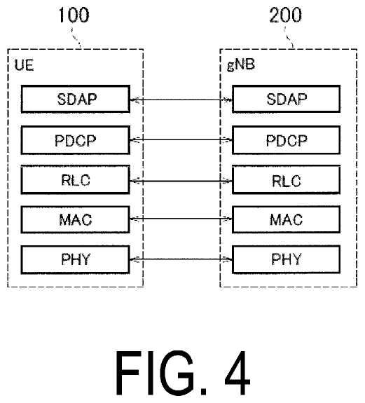

FIG. 4 is a diagram illustrating a configuration of a protocol stack of a radio interface of a user plane in the Uu interface, the user plane handling data.

As illustrated in FIG. 4, a radio interface protocol of the user plane in the Uu interface includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel.

The MAC layer performs preferential control of data, retransmission processing using a hybrid ARQ (HARQ), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, modulation and coding schemes (MCSs)) in the uplink and the downlink and resource blocks to be allocated to the UE 100.

The RLC layer transmits data to the RLC layer on the receiving end by using functions of the MAC layer and the PHY layer. Data and control information are transmitted between the RLC layer of the UE 100 and the RLC layer of the gNB 200 via a logical channel.

The PDCP layer performs header compression and decompression, and encryption and decryption.

The SDAP layer performs mapping between an IP flow as the unit of QoS control by a core network and a radio bearer as the unit of QoS control by an Access Stratum (AS). Note that, when the RAN is connected to the EPC, the SDAP may not be provided.

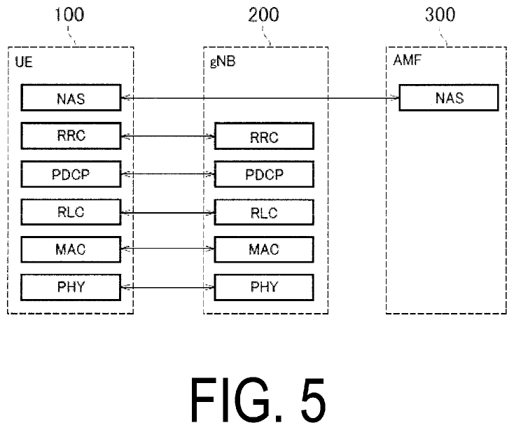

FIG. 5 is a diagram illustrating a configuration of a protocol stack of a radio interface of a control plane in the Uu interface, the control plane handling signalling (control signal). Note that FIG. 5 illustrates an Access and Mobility Management Function (AMF) as a node included in the 5GC.

As illustrated in FIG. 5, the protocol stack of the radio interface of the control plane in the Uu interface includes a Radio Resource Control (RRC) layer and a Non-Access Stratum (NAS) layer instead of the SDAP layer illustrated in FIG. 4.

RRC signalling for various configurations is transmitted between the RRC layer of the UE 100 and the RRC layer of the gNB 200. The RRC layer controls a logical channel, a transport channel, and a physical channel according to establishment, reestablishment, and release of a radio bearer. When a connection between the RRC of the UE 100 and the RRC of the gNB 200 (RRC connection) exists, the UE 100 is in an RRC connected state. When a connection between the RRC of the UE 100 and the RRC of the gNB 200 (RRC connection) does not exist, the UE 100 is in an RRC idle state. When the RRC connection is suspended, the UE 100 is in an RRC inactive state.

The NAS layer which is higher than the RRC layer performs session management, mobility management, and the like. NAS signalling is transmitted between the NAS layer of the UE 100 and the NAS layer of the AMF 300.

Note that the UE 100 includes an application layer other than the protocol of the radio interface.

Protocol Stack in PC5 Interface

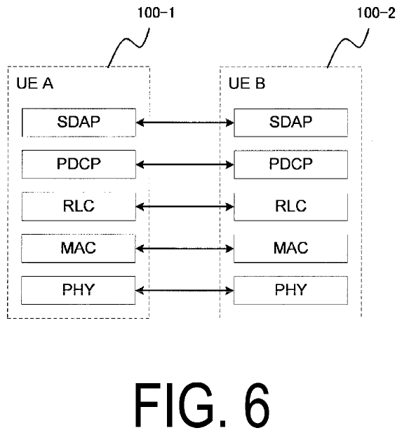

FIG. 6 is a diagram illustrating a configuration example of a protocol stack of a user plane in the PC5 interface.

As illustrated in FIG. 6, the protocol of the user plane in the PC5 interface includes a PHY layer, a MAC layer, an RLC layer, a PDCP layer and an SDAP layer, similarly to the protocol of the user plane in the Uu interface.

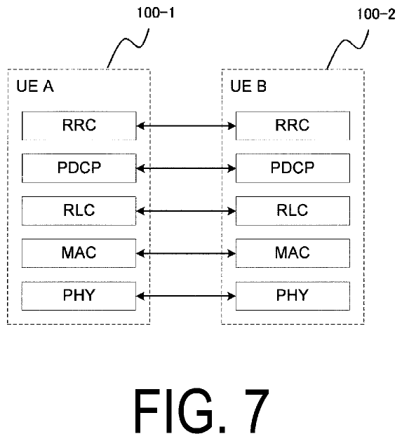

FIG. 7 is a diagram illustrating a configuration example of a protocol stack of a control plane in the PC5 interface.

As illustrated in FIG. 7, the protocol of the control plane in the PC5 interface also includes a PHY layer, a MAC layer, an RLC layer, a PDCP layer and an RRC layer, similarly to the protocol of the control plane in the Uu interface.

In the MAC layer of the user plane, data is transmitted via a transport layer (Sidelink Control Channel (SCCH), Sidelink Transport Channel (STCH), and Sidelink Broadcast Control Channel (SBCCH)) in the sidelink communication. In the MAC layer of the control plane, control information is transmitted via the transport layer in the sidelink communication. Furthermore, the MAC layer of at least one of the planes performs priority handling between uplink communication and sidelink communication, report of Channel State Information (CSI) of the sidelink, and the like.

The RRC layer of the control plane performs transfer of a PC5-RRC message between the peer UEs 100-1 and 100-2, maintenance and management of PC5-RRC connection, detection of a Failure of the sidelink radio link in the PC5-RRC connection, and the like.

Note that the PC5-RRC connection refers to a logical connection between two UEs 100 for a pair of IDs of a source and a destination in layer 2. The PC5-RRC connection is established after the corresponding PC5 unicast link is established. The PC5-RRC connection and the PC5 unicast link have a one-to-one relationship. The UE 100 can have a plurality of PC5-RRC connections with one or more other UEs with different pairs of IDs of the source and destination in layer 2. The UE 100 releases the PC5-RRC connection when the UE 100 is not interested in the sidelink communication or when a layer 2 link release procedure is complete. The UE 100-1 and UE 100-2 connected by PC5-RRC connection is brought into a PC5-RRC connected state.

Physical Channel of Sidelink Communication

Physical channels in the sidelink communication include a Physical Sidelink Control Channel (PSCCH) and a Physical Sidelink Shared Channel (PSSCH). Physical channels in the sidelink communication include a Physical Sidelink Feedback Channel (PSFCH) and a Physical Sidelink Broadcast Channel (PSBCH).

In the PSCCH, control information related to resources used by the UE 100 in the PSSCH is transmitted. In the PSCCH, different pieces of control information (Sidelink Control Information (SCI)) may be transmitted in two stages. In the PSSCH, Transport Blocks (TBs) of data, and a part of control information for an HARQ procedure and the like are transmitted. In the PSFCH, HARQ feedback information is transmitted from the UE 100-2, which is the reception target of the PSSCH transmission, to the UE 100-1, which has performed the transmission. The PSFCH may be applied to unicast transmission and groupcast transmission. In the PSBCH, Direct Frame Numbers (DFNs), information on synchronization, and the like are transmitted.

Operation Example

An operation example will be described. The operation example will be described in the following order.

Example 1: UEs 100 that are PC5-RRC connected together share a CBR measurement result.

Example 2-1: notify a PC5-RRC connected UE 100 of change of a transmission resource.

Example 2-2: notify a PC5-RRC connected UE 100 of free (or unused) resources.

Example 3-1: the receiving UE notifies the transmitting UE of timing when sidelink reception is not available.

Example 3-2: the transmitting UE notifies the receiving UE of timing when sidelink transmission is not available.

Example 3-3: the UE notifies the peer UE of timing when transmission and reception are not available.

### EXAMPLE 1

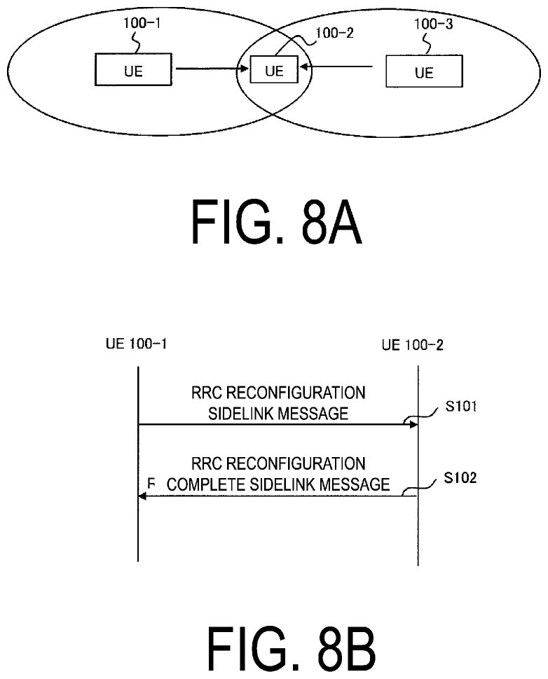

FIG. 8A is a diagram illustrating an example of a hidden node problem. As illustrated in FIG. 8A, the UE 100-1 and the UE 100-3 are located out of reach of radio signals from each other. In other words, the UE 100-1 cannot successfully receive radio signals transmitted from the UE 100-3. The UE 100-3 cannot successfully receive radio signals transmitted from the UE 100-1. Thus, even though the UE 100-1 and the UE 100-3 perform carrier sensing, each of the UEs 100-1 and 100-3 detects no radio signals transmitted from the other.

In such a situation, as illustrated in FIG. 8A, a case is considered in which the UE 100-2 is located in a range in which the UE 100-2 can receive radio signals from the UE 100-1 and in a range in which the UE 100-2 can receive radio signals from the UE 100-3. A case is considered in which the UE 100-1 and the UE 100-3 transmit radio signals to the UE 100-2 by using the same radio resource.

In this case, the UE 100-2 attempts to receive the radio signal transmitted from the UE 100-1 and the radio signal transmitted from the UE 100-3. However, since the radio signals are transmitted by using the same radio resource, one of the radios signals interferes with the other, leading to a failure in successful reception.

Such a problem in which the UE 100-2 cannot successfully receive radio signals as described above is the hidden node problem.

The UEs 100-1 and 100-2 communicate wirelessly with each other by sidelink communication, and the UEs 100-2 and 100-3 communicate wirelessly with each other by sidelink communication. Thus, the hidden node problem may also occur in the sidelink communication.

In the present embodiment, communication control information is provided that allows interference in the receiving UE 100-2 to be avoided.

In the communication control method in Example 1, the UE 100-2 in the PC5-RRC connected state with the UE 100-1 measures the channel utilization. An example of such a channel utilization is a Channel Busy Ratio (CBR). The UE 100-2 transmits the measured channel utilization to the UE 100-1.

The UE 100-1 reselects a transmission resource, based on the received channel utilization. Alternatively, the UE 100-1 can request a new transmission resource from the gNB 200, based on the received channel utilization and receive allocation of the transmission resource. Furthermore, the UE 100-1 can perform both reselection and reception of resource allocation.

The transmitting UE 100-1 transmits data or the like to the receiving UE 100-2 by using the transmission resource reselected in this way or the new transmission resource allocated in this way. In this case, the receiving UE 100-2 receives transmission of data or the like from the UE 100-1 by using a radio resource different from that of another UE 100-3. Accordingly, the receiving UE 100-2 can receive the data or the like transmitted from the transmitting UE 100-1 with no interference with transmission from another UE 100-3. Thus, Example 1 allows interference due to the hidden node problem to be avoided.

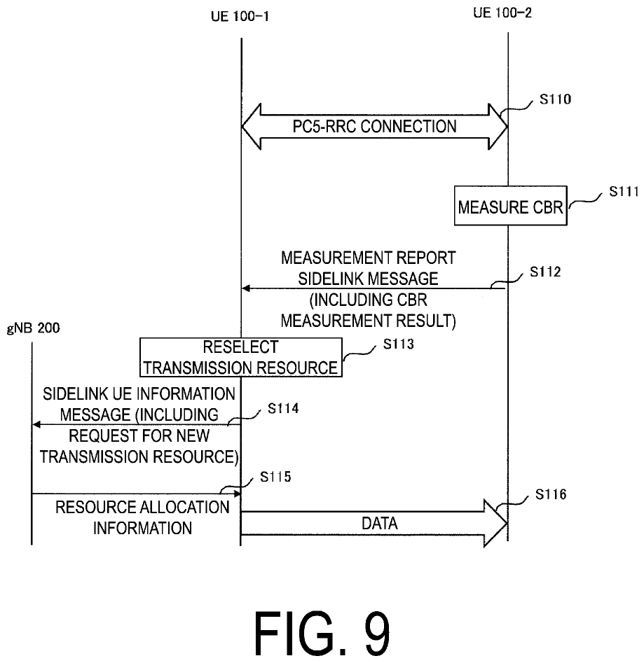

An operation example according to Example 1 will be described. FIG. 9 is a diagram illustrating an operation example according to Example 1.

In step S110, the UE 100-1 and the UE 100-2 make a PC5-RRC connection to each other. FIG. 8B is a diagram illustrating an example of a procedure for changing the PC5-RRC connection. This change procedure is performed when a sidelink Data Radio Bearer (DRB) is established, changed and released.

In step S101, the UE 100-1 transmits an RRC reconfiguration sidelink (RRCReconfigurationSidelink) message to the UE 100-2. The RRC reconfiguration sidelink message is a message exchanged between the UEs 100. The RRC reconfiguration sidelink message includes configuration information related to the PC5-RRC connection between the UEs 100. The RRC reconfiguration sidelink message is a message used (only) in unicast transmission.

In step S102, the UE 100-2 transmits an RRC reconfiguration complete sidelink (RRCReconfigurationCompleteSidelink) message to the UE 100-1. The RRC reconfiguration complete sidelink message is a message transmitted to confirm that the PC5-RRC reconfiguration is successfully complete.

As described above, the UE 100-1 and the UE 100-2 are connected by a PC5-RRC connection and enter the PC5-RRC connected state.

Returning to FIG. 9, in step S110, when the UE 100-1 and the UE 100-2 enter the PC5-RRC connected state, in step S111, the UE 100-2 performs CBR measurement. The controller 130 of the UE 100-2 may perform the CBR measurement. The CBR measured at subframe n is defined, for example, as follows.

1) For the PSSCH, the CBR is a portion of subchannels in which the Sidelink-Received Signal Strength Indicator (S-RSSI) of a resource pool measured by the UE 100-2 is sensed on subframes [n−100, n−1], the portion exceeding a (pre)configured threshold value.

2) For the PSCCH, the CBR is a resource portion of the PSCCH pool exceeding the (pre)configured threshold value, in which the S-RSSI of the PSCCH pool measured by the UE 100-2 is sensed on subframe [n−100, n−1] in a (pre)configured pool. However, the PSCCH pool is assumed to include resources having a size of two consecutive Physical Resource Blocks (PRBs) in the frequency domain. The (pre)configured pool is a pool configured such that the PSCCH may be transmitted in a non-adjacent resource block together with a corresponding PSSCH.

The UE 100-2 may perform the CBR measurement on radio resources used in the sidelink communication. The UE 100-2 may perform the CBR measurement on frequencies (or channels) used in the sidelink communication. In the latter case, the UE 100-2 may perform the CBR measurement on candidate resources within the time period of a preconfigured sensing window. The CBR may thus be an example of the channel utilization.

In Step S112, the UE 100-2 transmits the measurement result of the CBR to the UE 100-1. In this case, UE 100-2 may transmit, to the UE 100-1, a measurement report sidelink (MeasurementReportSidelink) message including the measurement result of the CBR. The measurement report sidelink message is a message used between the UEs 100 to notify of the measurement result for the NR sidelink.

Note that the UE 100-2 may report the CBR measurement result (or may perform the CBR measurement) (only) when the CBR measurement is configured in SL-MeasConfig, which is an information element included in the RRC reconfiguration sidelink message. In this case, the RRC reconfiguration sidelink message is a message transmitted from the UE 100-1.

SL-MeasConfig may configure a CBR measurement target. Examples of the CBR configuration target may include a subband, a pool, a frequency, and a PRB.

The CBR measurement result may be obtained per frequency, per pool, per subband, or per PRB. Alternatively, the CBR measurement result may include those for all of the frequency, pool, subband, and PRB.

In step S113, the UE 100-1 reselects a transmission resource, based on the received CBR measurement result. This processing corresponds to a case of allocation of transmission resources initiated by UE 100-1. The UE 100-1 may reselect transmission frequencies, transmission pools, transmission subbands or transmission PRBs as transmission resources. For example, the UE 100-1 performs exclusion, from the selection target of transmission resources, of subbands in which the CBR measurement result is poor (or the CBR measurement result is lower than a threshold value), or the like.

In step S114, the UE 100-1 requests a new transmission resource from the gNB 200. This processing corresponds to a case of allocation of resources initiated by the gNB 200. In this case, the UE 100-1 may transmit, to the gNB 200, a sidelink UE information (SidelinkUEInformation) message including the request. The sidelink UE information message is a message used when the UE 100 is interested in the V2X sidelink communication, when the UE 100 requests the network to allocate or release transmission resources, and the like. Note that the UE 100-1 may transmit the sidelink UE information message including information (or a cause value) indicating that the CBR result for the counterpart UE 100-2 has degraded (or is lower than the threshold value). Alternatively, the UE 100-1 may transmit, to the gNB 200, the sidelink UE information message including the CBR measurement result received in step S112.

In step S115, the gNB 200 performs resource allocation for the sidelink communication and transmits allocation information to the UE 100-1. The allocation information is transmitted using the Physical Downlink Control Channel (PDCCH).

In step S116, the UE 100-1 uses the reselected resource (step S113) or the allocated resource (step S115) to transmit control information and data to the UE 100-2.

Note that in the example described above, description is given of an example in which the UE 100-1 performs both the reselection of a transmission resource (step S113) and the resource request (step S114). For example, the UE 100-1 may perform either one of the reselection and the resource request. The two processing operations (step S113 and step S114) may be performed when the CBR measurement result is worse (or lower) than the threshold value. Alternatively, when no appropriate transmission resource reselection candidate is found in step S113 (in other words, when the CBR measurement result is degraded for all the allocated transmission resources and the UE 100-1 fails to reselect a transmission resource), the process of step S113 may be performed.

In the above-described example, CBR measurement has been described. Instead of the CBR measurement, a Channel Occupy Ratio (CR) may be used. The CR evaluated in subframe n is defined as the total number of subchannels used for transmission in subframes [n−a, n−1] and granted in subframes [n, n+b], divided by the total number of subchannels configured in the transmission pool over [n−a, n+b]. Here, “a” is a positive integer, “b” is “0” or a positive integer, and “a” and “b” are such that a+b+1=1000, a≥500, and n+b do not exceed the last transmission occasion of the grant for the current transmission.

The UE 100-2 may use the controller 130 to perform the CR measurement, include the CR measurement result in the measurement report sidelink message, and transmit the measurement report sidelink message to the UE 100-1. The CR may be an example of the channel utilization.

The UE 100-1 can acquire the CBR measurement result for the UE 100-2 by performing the above-described operation example. Similarly, the UE 100-3 can acquire the CBR measurement result for the UE 100-2 by performing the above-described operation example with the UE 100-2. Thus, the CBR measurement result for the receiving UE 100-2 can be shared among the plurality of UEs 100-1 to 100-3.

Of course, by the UE 100-1 reselecting a transmission resource based on the CBR measurement result of the UE 100-2, interference at the receiving UE 100-2 can be hindered. However, by sharing the CBR measurement result as described above, the transmitting UEs 100-1 and 100-3 can also transmit data or the like by using different transmission resources, based on the CBR measurement result. Thus, the receiving UE 100-2 can successfully receive the data or the like without the interference.

### EXAMPLE 2-1

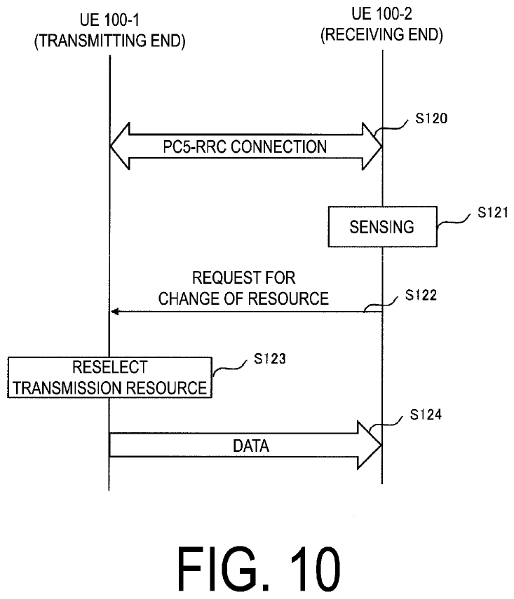

FIG. 10 is a diagram illustrating an operation example in Example 2-1. In the communication control method in Example 2-1, the receiving UE 100-2 in the PC5-RRC connected state with the transmitting UE 100-1 performs sensing to determine whether the resource used by the transmitting UE 100-1 for transmission is in use by another UE 100-3. When the UE 100-2 determines that the resource is in use by such another UE 100-3, the UE 100-2 transmits, to the transmitting UE 100-1, a request for change of the transmission resource currently used.

When receiving the request for change of the transmission resource, the transmitting UE 100-1 can change the transmission resource by reselection or the like. By changing the transmission resource, the transmitting UE 100-1 can transmit data or the like by using a resource different from the transmission resource used by such another UE 100-3. Thus, the receiving UE 100-2 can successfully receive the data or the like transmitted from the transmitting UE 100-1 with transmission from such another UE 100-3 not interfering with the UE 100-2.

FIG. 10 is a diagram illustrating an operation example of Example 2-1. The UE 100-1 corresponds to the transmitting end and the UE 100-2 corresponds to the receiving end.

In step S120, the UE 100-1 and the UE 100-2 are connected by a PC5-RRC connection and enter the PC5-RRC connected state. The UE 100-1 and the UE 100-2 enter the PC5-RRC connected state by, for example, performing the procedure illustrated in FIG. 8B.

In step S121, the receiving UE 100-2 performs sensing. To be more specific, the receiving UE 100-2 uses periods with no data transmission to sense the transmission resource currently used by the transmitting UE 100-1 to determine whether the transmission resource is in use by another UE (for example, UE 100-3). This determination may be referred to as interference determination. The receiving UE 100-2 may perform the interference determination by comparing a sensing result with a threshold value. The threshold value may be included in, for example, broadcast information broadcasted from the gNB 200 or an RRC reconfiguration (RRCReconfiguration) message transmitted from the gNB 200.

In step S122, the receiving UE 100-2 transmits the request for change of the transmission resource to the transmitting UE 100-1. The transmission resource may be represented by frequencies, resource pools, subbands, PRBs, or the like. The UE 100-2 may transmit the RRC reconfiguration sidelink message, the measurement report sidelink message, or a new message (message such as UEAssistanceInformationSidelink) that include the request for change of the transmission resource to transmit the request for change.

In step S123, the transmitting UE 100-1 reselects a transmission resource. For selection of a transmission resource, processing same as, and/or similar to, the processing in Example 1 (step S113) may be performed. Instead of reselecting a transmission resource, the transmitting UE 100-1 may request a new transmission resource from the gNB 200 (step S114) as is the case with Example 1. Alternatively, the transmitting UE 100-1 may perform both the reselection of a transmission resource (step S123) and the request for a new transmission resource (step S114).

In step S124, the transmitting UE 100-1 uses the reselected transmission resource to transmit data to the receiving UE 100-2.

### EXAMPLE 2-2

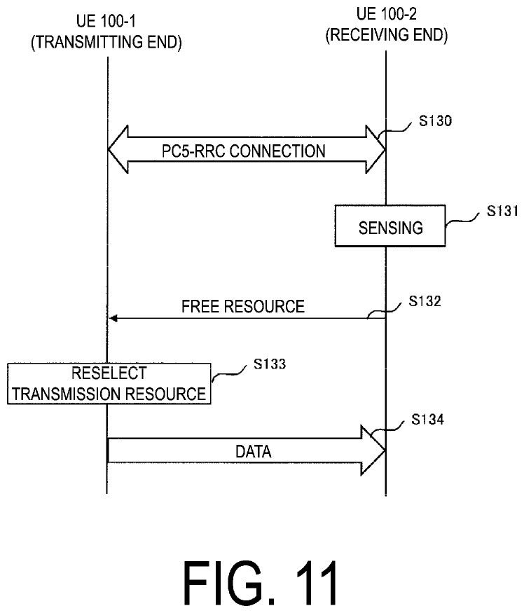

FIG. 11 is a diagram illustrating an operation example of Example 2-2. In Example 2-1, the receiving UE 100-2 transmits the request for change of the transmission resource. However, in Example 2-2, free (or unused. The same applies to the description below) resources are transmitted as transmission resources. When the receiving UE 100-2 finds and transmits a free transmission resource to the transmitting UE 100-1, the UE 100-1 can transmit data or the like by using the transmission resource not used by another UE. Thus, the receiving UE 100-2 can successfully receive the data from the UE 100-1 transmitted by the transmission resource not used by another UE (for example, the UE 100-3) without interference. Thus, also in Example 2-2, the receiving UE 100-2 can successfully receive the data and the like transmitted from the transmitting UE 100-1 without being subjected to interference due to the hidden node problem.

In step S130, the UE 100-1 and the UE 100-2 enter the PC5-RRC connected state.

In step S131, the receiving UE 100-2 performs sensing to search for a free transmission resource. The sensing may be CBR measurement as is the case with Example 2-1. As is the case with Example 2-1, whether the transmission resource is free may be determined using a threshold value preconfigured by the gNB 200 (preconfiguration). Furthermore, as is the case with Example 2-1, the UE 100-2 may search for a frequency, a resource pool, a subband, or a PRB as a transmission resource. The UE 100-2 may hold free transmission resources in a memory or the like in list form.

In step S132, the UE 100-2 transmits free transmission resources to the transmitting UE 100-1 as a transmission resource. The free transmission resources may be represented by frequencies, resource pools, subbands, or PRBs. The UE 100-2 may transmit free transmission resources in list form.

In step S133, the transmitting UE 100-1 reselects an appropriate transmission resource from among the free transmission resources. In this case, the UE 100-1 may notify gNB 200 of the free transmission resources. The notification may be performed by the sidelink UE information message.

In step S134, the transmitting UE 100-1 uses the reselected transmission resource to transmit the data to UE 100-2.

### EXAMPLE 3-1

In Examples 3-1 to 3-3, the UE 100 notifies the peer UE of information regarding timings when reception (which may hereinafter be referred to as “sidelink reception”), transmission (which may hereinafter be referred to as “sidelink transmission”), and the like of the sidelink communication are not available.

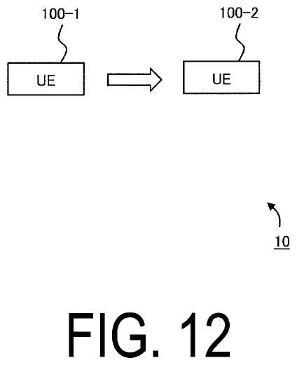

FIG. 12 illustrates an example in which the transmitting UE 100-1 and the receiving UE 100-2 are attempting to perform sidelink communication.

For example, even when the transmitting UE 100-1 transmits data or the like at the timing when the sidelink reception is not available, the receiving UE 100-2 cannot successfully receive the data or the like. Accordingly, the transmitting UE 100-1 may perform retransmission. In this case, no matter how many times the transmitting UE 100-1 performs transmission, the sidelink reception is not available for the receiving UE 100-2 at this timing, and thus power consumption may be wasted.

Thus, in Example 3-1, the receiving UE 100-2 identifies the timing when sidelink reception is not available, and transmits the information of the identified timing to the transmitting UE 100-1. Thus, the transmitting UE 100-1 performs no transmission of data or the like at the timing when the receiving UE 100-2 cannot successfully receive data or the like, and can perform transmission at any other timing. Thus, the transmitting UE 100-1 performs no retransmission, leading to no possibility of wasteful power consumption and enabling the power consumption to be reduced.

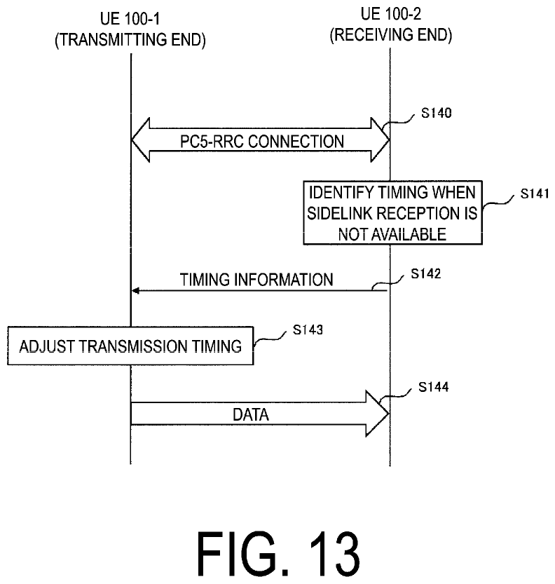

FIG. 13 is a diagram illustrating an operation example of Example 3-1. The UE 100-1 corresponds to the transmitting end and the UE 100-2 corresponds to the receiving end.

In step S140, the transmitting UE 100-1 and the receiving UE 100-2 are subjected to a PC5-RRC connection and enter the PC5-RRC connected state.

In step S141, the receiving UE 100-2 identifies the timing when the sidelink reception is not available.

Methods for identifying such timing are, for example, as described below. In other words, the UE 100-2 may identify the subframe in which DL(Down Link) reception in the Uu interface is prioritized to be the timing when the sidelink reception is not available. The subframe in which reception from the gNB 200 is prioritized may be Discontinuous Reception (DRX) OnDuration or the like. If the DRX operation is performed between the UE 100-2 and the gNB 200, then during the DRX OnDuration period, the UE 100-2 monitors the Physical Downlink Control Channel (PDCCH) and receives a paging message that arrives at least once during the period. Accordingly, the UE 100-2 may identify this period to be the timing when the sidelink reception is not available.

Alternatively, the UE 100-2 may identify the subframe in which sidelink reception from another UE PC5-RRC connected to the UE 100-2 (which may be the UE 100-1 or a UE other than the UE 100-1) is prioritized to be the timing when the sidelink reception is not available. An example of such a subframe may be the DRX OnDuration period in the sidelink communication. The UE 100-2 monitors, for example, the PSCCH in this period, and thus may identify the period to be the timing when the sidelink reception is not available.

Alternatively, the UE 100-2 may determine timing when the Measurement is performed to be the timing when the sidelink reception is not available. The timing when the Measurement is performed includes timing when the Measurement is performed on the gNB 200 and timing when the Measurement is performed on another UE.

Alternatively, the UE 100-2 may identify timing based on traffic as the timing when the sidelink reception is not available. The timing based on traffic may be, for example, the timing of a resource allocated (configured) in advance in accordance with Semi-Persistence Scheduling (SPS).

In step S142, the receiving UE 100-2 transmits, to the transmitting UE 100-1, timing information indicating the timing when the sidelink reception is not available. Such timing may be referred to as a “reception gap” (or “Rx gap”).

The timing information may be represented in a bitmap format. For example, each bit may be associated with a subframe or may be associated with a resource pool in the time direction.

Alternatively, such timing information may be information for each frequency, for each resource pool, or for each subband. In other words, the timing information may be associated with each frequency, each resource pool, or each subband. Alternatively, the timing information for each frequency, the timing information for each resource pool, and the timing information for each subband may be brought together, and the resultant information may be transmitted as the timing information.

Alternatively, such timing information may include a plurality of pieces of timing information in a bitmap format. In other words, in order to express complicated timings, a plurality of bitmaps may be indicated as a plurality of pieces of timing information.

Alternatively, such timing information may be interpreted as being periodically repeated. In other words, the timing information may be interpreted as a bit map being repeated. For example, when the transmitted timing information is “1011”, the UE 100-1, when receiving the timing information, interprets the timing information as a repetition of “1011”, in other words, “1011 1011 1011”. In this case, for example, when the period is assumed to be set to “8”, the UE 100-1, when receiving the timing information, may interpret the timing information as “1011 0000” (missing portions may be assumed to be “0s”).

In step S143, the transmitting UE 100-1 adjusts the transmission timing. Based on the received timing information, the UE 100-1 may adjust the transmission timing so that any timing other than the timing when the receiving UE 100-2 performs no reception becomes the transmission timing.

In step S144, the transmitting UE 100-1 transmits the data or the like to the receiving UE 100-2 at the adjusted transmission timing.

### EXAMPLE 3-2

In Example 3-1 described above, the information regarding the timing when the sidelink reception is not available is transmitted. In Example 3-2, the information regarding the timing when the sidelink transmission is not available is transmitted.

For example, even when the receiving UE 100-2 performing the DRX operation wakes up at the timing when the transmitting UE 100-1 performs no transmission, the receiving UE 100-2 receives no data or the like from the transmitting UE 100-1. In this case, the receiving UE 100-2 wakes up in spite of the lack of a receiving opportunity, the power consumption is wasted.

Thus, the transmitting UE 100-1 transmits, to the receiving UE 100-2, information regarding the timing when the transmitting UE 100-1 performs no transmission in the sidelink communication. This hinders, for example, the receiving UE 100-2 from waking up and performing a reception operation, at the timing when the transmitting UE 100-1 performs no transmission. Accordingly, the receiving UE 100-2 can reduce the power consumption.

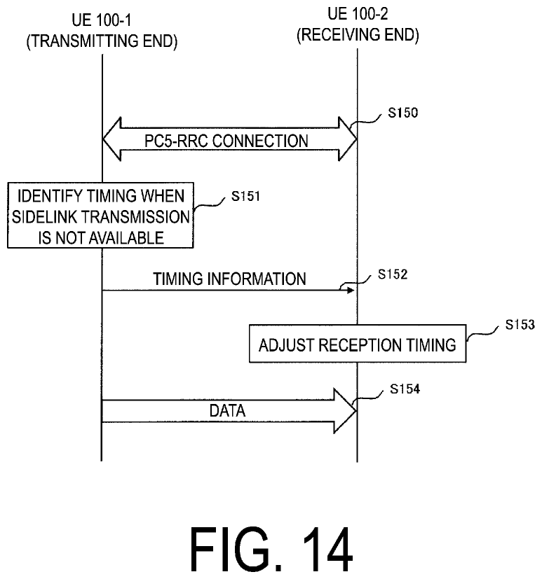

FIG. 14 is a diagram illustrating an operation example of Example 3-2.

In step S150, the transmitting UE 100-1 and the receiving UE 100-2 make a PC5-RRC connection to each other. The UE 100-1 and UE 100-2 enter the PC5-RRC connected state.

In step S151, the transmitting UE 100-1 identifies the timing when the sidelink transmission is not available.

Methods for identifying such timing are, for example, as described below. In other words, the UE 100-1 may identify the subframe in which Up Link (UL) transmission of the Uu interface is prioritized to be the timing when the sidelink transmission is not available. Such timing may be, for example, the timing of Configured Grant. Configured Grant is, for example, a radio resource of the Physical Uplink Sidelink Channel (PUSCH) allocated in advance to the UE 100-1 without the UE 100 transmitting a scheduling request to the gNB 200. At such timing, the UE 100 is likely to transmit data or the like to the gNB 200, and thus such timing may be identified to be the timing when the sidelink transmission is not available.

Alternatively, the UE 100-1 may identify the subframe in which the UE 100-1 and another UE (which may be the UE 100-2 or a UE other than the UE 100-2) that are PC5-RRC connected together prioritize the sidelink transmission, to be the timing when the sidelink transmission is not available. An example of such a subframe may be the DRX OnDuration period in the sidelink communication.

Alternatively, as is the case with Example 3-1, the UE 100-1 may identify the timing based on traffic, for example, timing to which the SPS is allocated, as the timing when the sidelink transmission is not available.

In step S152, the transmitting UE 100-1 transmits, to the receiving UE 100-2, timing information indicating the timing when the sidelink transmission is not available. Such timing may be referred to as a “transmission gap” (or “Tx gap”).

As is the case with Example 3-1, the timing information may be represented in the bitmap format, and each bit may be associated with a subframe or with a resource pool in the time direction. As is the case with Example 3-1, the timing information may be information for each frequency, for each pool, or for each subband, or may be information for each frequency, for each pool, and for each subband. Furthermore, the timing information may include a plurality of pieces of timing information in the bitmap format as is the case with Example 3-1. Furthermore, the timing information may be interpreted as a bit map being repeated, as is the case with Example 3-1.

In step S153, the receiving UE 100-2 adjusts the reception timing. Based on the received timing information, the UE 100-2 may adjust the reception timing to timing other than the timing when the transmitting UE 100-1 performs no transmission. For example, the UE 100-2 need not wake up (or may skip the reception operation) at the timing when the UE 100-2 performs no transmission.

In step S154, the receiving UE 100-2 receives the data or the like transmitted from the transmitting UE 100-1 at the adjusted reception timing.

### EXAMPLE 3-3

In Example 3-1 described above, the timing when the sidelink reception is not available is transmitted, and in Example 3-2 described above, the timing when the sidelink transmission is not available is transmitted. Example 3-3 described below corresponds to an example of mutual notification of timing when the transmission and reception of the sidelink communication are not available, in other words, timing when the sidelink communication is not available. Such timing may be referred to as a “sidelink gap” (or “Sidelink gap”).

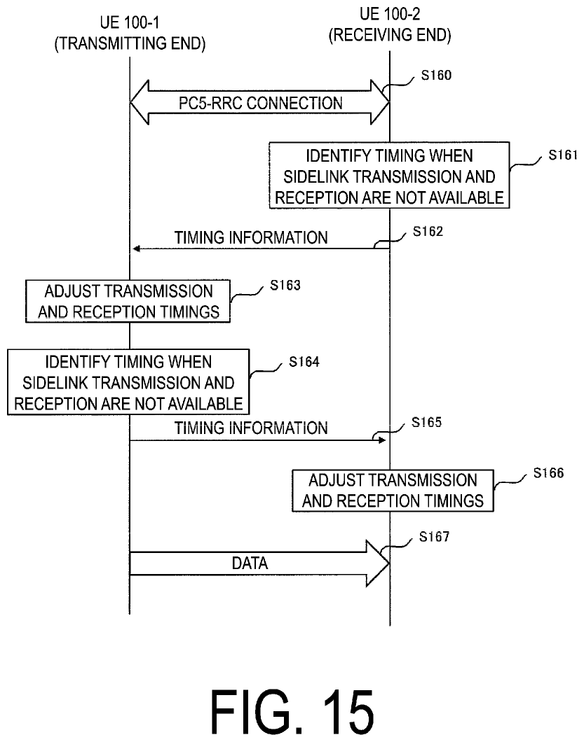

FIG. 15 is a diagram illustrating an operation example in which the receiving UE 100-2 transmits, to the transmitting UE 100-1, the timing when the sidelink transmission and reception are not available.

In step S160, the UE 100-1 and UE 100-2 make a PC5-RRC connection to each other and enter the PC5-RRC connected state.

In step S161, the receiving UE 100-2 identifies the timing when the sidelink transmission and reception are not available. Methods of identifying may be the same as, or similar to, those in step S141 in Example 3-1. In other words, the UE 100-1 may identify the subframe in which DL(Down Link) reception in the Uu interface is prioritized to be the timing when the sidelink transmission and reception are not available. Alternatively, the UE 100-2 may determine the subframe in which the UE 100-2 and another UE that are PC5-RRC connected together prioritize the sidelink reception to be the timing when the sidelink transmission and reception are not available. Alternatively, the UE 100-2 may determine the timing when Measurement is performed or the timing based on traffic to be the timing when the sidelink transmission and reception are not available.

In step S162, the receiving UE 100-2 transmits, to the transmitting UE 100-1, timing information indicating the timing when the sidelink transmission and reception are not available. Such timing information may be represented as is the case with Example 3-1. In other words, the timing information may be in the bitmap format, or may include a plurality of pieces of timing information in the bitmap format. The bitmap information may be information for each frequency, for each resource pool, or for each subband, or may include all of these pieces of information. Furthermore, the bitmap information may be interpreted as being repeated periodically.

In step S163, the transmitting UE 100-1 may adjust the transmission and reception timings by adjusting the transmission timing as is the case with step S143 (FIG. 13) of Example 3-1. In other words, the transmitting UE 100-1 may make an adjustment to avoid performing transmission at the timing when the transmission and reception are not available.

In step S164, the transmitting UE 100-1 identifies the timing when the sidelink transmission and reception are not available. The identification of the timing when the sidelink transmission and reception are not available is the same as, or similar to, that in step S151 in Example 3-2. For example, the UE 100-1 may identify the subframe in which Up Link (UL) transmission of the Uu interface is prioritized or in which another UE (which may be the UE 100-2 or a UE other than the UE 100-2) that is PC5-RRC connected to the UE 100-1 prioritize the sidelink transmission, to be the timing when the sidelink transmission and reception are not available. Alternatively, the UE 100-1 may identify the timing based on traffic as the timing when the sidelink transmission and reception are not available.

In step S165, the transmitting UE 100-1 transmits, to the receiving UE 100-2, timing information indicating the timing when the sidelink transmission and reception are not available. As is the case with Example 3-2, the timing information may be in the bitmap format or may include a plurality of pieces of timing information in the bitmap format. The bitmap information may be information for each frequency, for each resource pool, or for each subband, or may include all of these pieces of information. Furthermore, the bitmap information may be interpreted as being repeated periodically.

In step S166, the receiving UE 100-2 adjusts the transmission and reception timings. As is the case with Example 3-2, the UE 100-2 need not wake up (or may skip the reception operation) at the timing when the UE 100-2 performs neither transmission nor reception (or performs no transmission).

In step S167, the transmitting UE 100-1 transmits the data or the like at the adjusted timing, and the receiving UE 100-2 receives the data or the like transmitted from the transmitting UE 100-1 at the adjusted timing.

Note that in the example described above with reference to FIG. 15, the receiving UE 100-2 first identifies the timing when the sidelink transmission and reception are not available and the transmitting UE 100-1 subsequently identifies the timing when the sidelink transmission and reception are not available. It does not matter whether the receiving UE 100-2 or the transmitting UE 100-1 first makes identification. Accordingly, the transmitting UE 100-1 may first identify the timing when the sidelink transmission and reception are not available and the receiving UE 100-2 may subsequently identify the timing when the sidelink transmission and reception are not available.

Other Embodiments

In Examples 3-1 to 3-3 described above, the UE 100 notifies the peer of the timing when the transmission and/or reception is not available, but the embodiment is not limited to this. For example, the UE 100 may notify the peer of the timing when the transmission and/or reception is enabled (or timing when the transmission and/or reception is expected to be performed). In this case, in Examples 3-1 to 3-3, the “timing when the transmission and/or reception is not available” may be interpreted as the “timing when the transmission and/or reception is enabled”.

A program causing a computer to execute each of the processes performed by the UE 100 or the gNB 200 may be provided. The program may be recorded on a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing the processes to be performed by the UE 100 or the gNB 200 may be integrated, and at least part of the UE 100 or the gNB 200 may be configured as a semiconductor integrated circuit (a chipset or an SoC).

Although an embodiment has been described in detail with reference to the drawings, a specific configuration is not limited to those described above, and various design modifications and the like can be made without departing from the gist. All of or a part of the examples can be combined together as long as the combination remains consistent.

### REFERENCE SIGNS

10: Mobile communication system
100 (100-1 to 100-3): UE
110: Receiver
120: Transmitter
130: Controller
200 (200-1): gNB
200-2: ng-eNB
210: Transmitter
220: Receiver
230: Controller
240: Backhaul communicator

1. A communication control method in a mobile communication system comprising a first user equipment and a second user equipment, the first user equipment and the second user equipment being configured to communicate wirelessly with each other by sidelink communication, the communication control method comprising:
transmitting, by the first user equipment, resource information to the second user equipment; and
receiving, by the second user equipment, the resource information, wherein
the resource information is information related to a timing when reception by the first user equipment is not available in the sidelink communication due to the timing used for other communication by the first user equipment.

2. The communication control method according to claim 1, further comprising
performing, by the second user equipment, no transmission to the first user equipment at the timing when the reception by the first user equipment is not available.

3. The communication control method according to claim 1, wherein
the resource information is information indicating a timing when transmission by the first user equipment is not available in the sidelink communication.

4. The communication control method according to claim 3, further comprising
not waking up the second user equipment at the timing when the transmission by the first user equipment is not available.

5. The communication control method according to claim 1, wherein
the resource information is information indicating a timing when transmission and reception by the first user equipment are not available in the sidelink communication.

6. The communication control method according to claim 5, further comprising
performing, by the second user equipment, no transmission to the first user equipment at the timing when the transmission and the reception by the first user equipment are not available, or not waking up the second user equipment at the timing when the transmission and the reception by the first user equipment are not available.

7. A first user equipment configured to communicate wirelessly with a second user equipment by sidelink communication, the first user equipment comprising:
a transmitter configured to transmit resource information to the second user equipment, wherein
the resource information is information related to a timing when reception by the first user equipment is not available in the sidelink communication due to the timing used for other communication by the first user equipment.

8. A chipset for controlling a first user equipment configured to communicate wirelessly with a second user equipment by sidelink communication, the chipset comprising
a processor and a memory coupled to the processor, the processor configured to
transmit resource information to the second user equipment, wherein
the resource information is information related to a timing when reception by the first user equipment is not available in the sidelink communication due to the timing used for other communication by the first user equipment.
